(19) United States
(12) Patent Application Publication
(10) Pub. No.: US 2015/0015478 A1
(43) Pub. Date: Jan. 15, 2015

(54) IR EMISSIVE DISPLAY FACILITATING REMOTE EYE TRACKING

(71) Applicant: SAMSUNG DISPLAY CO., LTD., Yongin-City (KR)

(72) Inventor: David M. Hoffman, Fremont, CA (US)

(21) Appl. No.: 14/251,510

(22) Filed: Apr. 11, 2014

Related U.S. Application Data
(60) Provisional application No. 61/845,118, filed on Jul. 11, 2013.

(51) Int. Cl. G06F 3/01; H04N 5/33

(52) U.S. Cl. CPC G06F 3/013; H04N 5/33
USPC 345/156

(57) ABSTRACT

An infrared (IR) emissive display device includes a display panel, an IR sensor, and a controller. The display panel includes IR pixels configured to emit IR light and arranged in a first two-dimensional (2D) pattern. The IR sensor is configured to sense IR signals emitted from the IR pixels and reflected off a user of the display device. The controller is configured to control the IR pixels, the IR signals, and the IR sensor to detect a gaze direction of an eye of the user. A method of facilitating remote eye tracking of the user on the display device includes emitting the IR signals from the IR pixels toward the user, sensing the IR signals reflected off the user with the IR sensor, and detecting the gaze direction of the user's eye from the sensed IR signals.

### CROSS-REFERENCE TO RELATED APPLICATION(S)

This application claims priority to and the benefit of U.S. Provisional Application 61/845,118, entitled “IR EMISSIVE DISPLAY FACILITATING REMOTE EYE TRACKING,” filed on Jul. 11, 2013, the entire content of which is herein incorporated by reference.

### BACKGROUND

1. Field

Aspects of embodiments of the present invention relate to an infrared (IR) emissive display capable of facilitating remote eye tracking.

2. Related Art

Gaze tracking (or eye tracking) permits electronic devices, such as computers, to know where a user is looking (such as on a display screen) without requiring further input from the user. Current approaches to determine where an observer is looking on a display screen have failed to be widely available in consumer devices. Some solutions use specially designed eyewear to directly track the eye. Other solutions do not use eyewear, but instead use a detached or remote device to track the eye. The existing remote eye tracking devices (devices that do not require eyewear) are usually an add-on solution that goes beneath the display (such as on a large bar beneath the screen). Such solutions are large standalone systems and have performance problems, such as when a user is wearing normal eyeglasses (which can cause strong specular reflection off the lenses that confound eye tracking of existing devices).

### SUMMARY

Embodiments of the present invention are directed to a display system that has embedded IR emitters that can be used to enable more robust and lower cost eye tracking solutions than comparable approaches. Further embodiments of the present invention utilize an embedded IR-emissive display to provide IR illumination to track gaze position and avoid interference with eyeglasses. Still further embodiments of the present invention are directed to methods of facilitating remote eye tracking using a display system with embedded IR emitters.

In an embodiment of the present invention, an infrared (IR) emissive display device is provided. The IR emissive display device includes: a display panel including IR pixels configured to emit IR light and arranged in a first two-dimensional (2D) pattern; an IR sensor configured to sense IR signals emitted from the IR pixels reflected off a user of the display device; and a controller configured to control the IR pixels, the IR signals, and the IR sensor to detect a gaze direction of an eye of the user.

The display panel may further include red pixels configured to emit red light, green pixels configured to emit green light, and blue pixels configured to emit blue light. The controller may be further configured to control the red pixels, the green pixels, and the blue pixels. The first 2D pattern of the IR pixels may correspond to a 2D pattern of the red pixels, the green pixels, or the blue pixels.

The IR pixels may be as numerous as the red pixels, the green pixels, or the blue pixels.

The IR sensor may be at a periphery of the display panel.

The IR sensor may include a plurality of IR sensors.

The IR sensors may be on multiple sides of the periphery of the display panel.

The IR emissive display device may further include a scan driver configured to generate and transmit scan signals to rows of the display panel, and a data driver configured to generate and transmit data signals to columns of the display panel. The controller may be further configured to control the scan driver and the data driver.

The IR pixels may be further configured to be driven by the scan signals or the data signals.

The controller may be further configured to control multiple ones of the IR pixels arranged in a second 2D pattern to concurrently emit the IR signals.

The IR sensor may be an IR camera.

The controller may be further configured to: control the IR pixels, the IR signals, and the IR sensor to detect specular reflections from the IR signals reflecting off a cornea of the user's eye; and detect the gaze direction of the user's eye by using the detected specular reflections off the cornea. The IR sensor may be further configured to detect a center of a pupil of the eye.

The controller may be further configured to control a spacing or orientation of selected ones of the IR pixels for emitting the IR signals to produce a more recognizable pattern of the specular reflections off the cornea.

The controller may be further configured to: control the IR pixels, the IR signals, and the IR sensor to detect specular reflections from the IR signals reflecting off eyeglasses of the user's eye; and detect the gaze direction of the user's eye by not using the detected specular reflections off the eyeglasses.

The controller may be further configured to select different ones of the IR pixels from which to emit the IR signals in response to the detected specular reflections off the eyeglasses.

The IR sensor may include a plurality of IR sensors. The controller may be further configured to select a different one of the IR sensors from which to sense the IR signals in response to the detected specular reflections off the eyeglasses.

In another embodiment of the present invention, a method of facilitating remote eye tracking on a display device including a display panel having IR pixels configured to emit IR light and arranged in a two-dimensional pattern, an IR sensor configured to sense IR signals emitted from the IR pixels reflected off a user of the display device, and a controller configured to control the IR pixels, the IR signals, and the IR sensor to detect a gaze direction of an eye of the user is provided. The method includes emitting the IR signals from the IR pixels toward the user, sensing the IR signals reflected off the user with the IR sensor, and detecting the gaze direction of the user's eye from the sensed IR signals.

The method may further include detecting specular reflections from the IR signals reflecting off a cornea of the user's eye. The detecting of the gaze direction of the user's eye may include using the detected specular reflections off the cornea.

The method may further include detecting specular reflections from the IR signals reflecting off eyeglasses of the user's eye. The detecting of the gaze direction of the user's eye may include not using the detected specular reflections off the eyeglasses.

The method may further include selecting different ones of the IR pixels from which to emit the IR signals in response to the detected specular reflections off the eyeglasses.

The IR sensor may include a plurality of IR sensors. The method may further include selecting a different one of the IR sensors from which to sense the IR signals in response to the detected specular reflections off the eyeglasses.

Embodiments of the present invention avoid the large, detached, remote, or standalone systems of comparable approaches to remote eye tracking as well as these systems' poor performance when tracking persons wearing traditional eyeglasses. Embodiments of the present invention are directed to using IR emitters, such as IR emissive pixels, and sensors to track the eye gaze position.

### BRIEF DESCRIPTION OF THE DRAWINGS

The accompanying drawings, together with the specification, illustrate example embodiments of the present invention. These drawings, together with the description, serve to better explain aspects and principles of the present invention.

FIG. 1 is a schematic diagram of an example IR emissive display device capable of facilitating remote eye tracking according to an embodiment of the present invention.

FIGS. 2-4 illustrate example operations of the IR emissive display device of FIG. 1 according to embodiments of the present invention.

FIG. 5 is a flowchart of an example method of facilitating remote eye tracking on the display device of FIG. 1 according to an embodiment of the present invention.

### DETAILED DESCRIPTION

Example embodiments of the present invention will now be described with reference to the accompanying drawings. In the drawings, the same or similar reference numerals refer to the same or similar elements throughout. Herein, the use of the term “may,” when describing embodiments of the present invention, refers to “one or more embodiments of the present invention.” In addition, the use of alternative language, such as “or,” when describing embodiments of the present invention, refers to “one or more embodiments of the present invention” for each corresponding item listed.

In one or more embodiments, a display device is provided. The display device includes IR emissive pixels and one or more image sensors. The IR emissive pixels are arranged in a two-dimensional (2D) pattern or arrangement, such as an array of emitters or a dispersed arrangement along both dimensions. For example, the display device may use a display panel having embedded light emitters (e.g., IR emitters dispersed like other pixels on the display panel, such as being dispersed in the same or similar pattern to pixels corresponding to one of the colors of a color display panel). In other embodiments, the IR emitters are less dense, such as every inch or centimeter in the horizontal and vertical directions of the display panel. The IR emitters facilitate tracking the eye gaze position (e.g., on the display panel) of a person using the display device, such as estimating where on a display screen a person is looking from a distance. The IR emitters may be useful for other purposes as well, such as for touch and hover detection in a display system.

Embodiments of the present invention provide for a system that determines where a person is looking from a distance by imaging (as with a camera) one or more IR reflections on the person's cornea while concurrently (for example, simultaneously) imaging the pupil. This allows the system, for example, to avoid using emitters that cause interference by strong specular reflections from the person's glasses (e.g., eyeglasses) and instead emphasize the more subtle eye reflections coming from other emitters reflecting off the person's cornea, iris, and pupil. One way of accomplishing this is by shifting the locations of the IR sources in response to interference caused by eyeglass reflections. Embodiments of the present invention provide for a dense (for example, a two-dimensional display panel size) arrangement of IR emissive pixels.

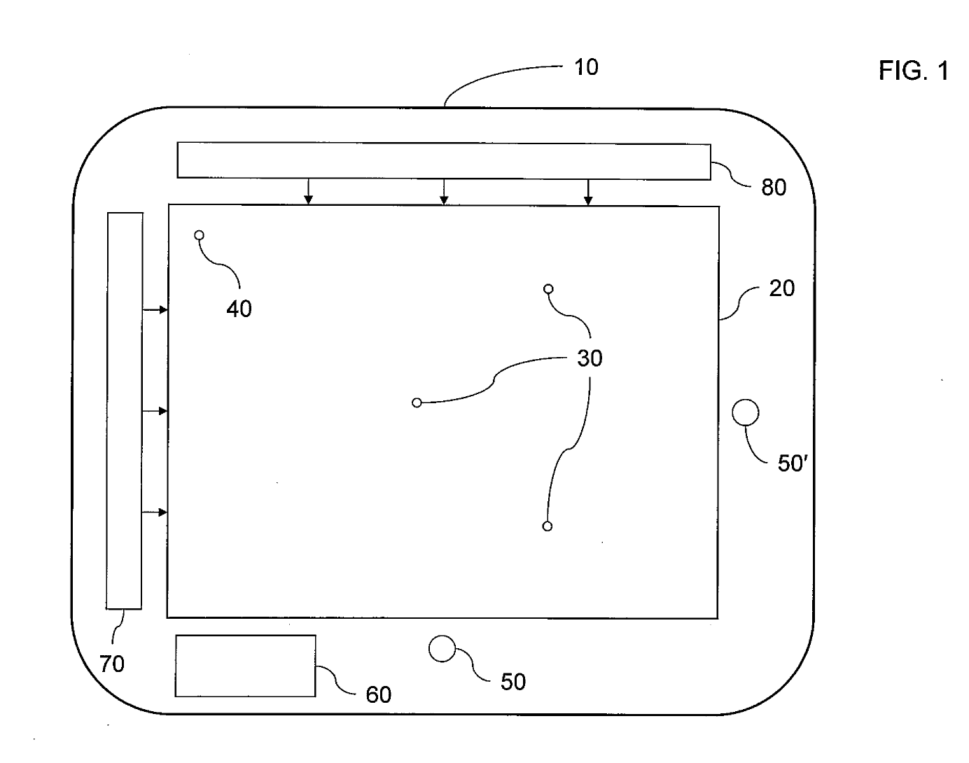

FIG. 1 is a schematic diagram of an example IR emissive display device 10 capable of facilitating remote eye tracking according to an embodiment of the present invention.

The display device 10 includes a display panel 20, an IR sensor 50 (such as an IR camera or remote gaze tracking camera), and a controller 60. The display device 10 may further include a scan driver 70 and a data driver 80. The display panel 20 may be a flat panel display panel, such as an organic light emitting diode display panel, for displaying images (for example, color images using red, green, and blue pixels 40 configured to respectively emit red, green, and blue light) to a user or viewer of the display panel. The display panel 20 includes IR sources (emitters), such as IR emissive pixels (or IR pixels) 30 dispersed along both dimensions among the other pixels 40 of the display panel 20. For example, the IR pixels 30 may be at regular intervals, such as every inch or every centimeter in both the row and column directions of the display panel 20, or may be in the same or similar arrangement (for example, a corresponding relationship) to one of the other color pixels 40 (such as the red pixels, the green pixels, or the blue pixels) of the display panel 20.

The IR pixels 30 are configured to emit IR light as emitted IR signals. While the IR emitters are referred to as “IR pixels” throughout, this is for convenience of description, and not to imply that the IR pixels 30 necessarily take part in the picture generation of the display device (as with, for example, the red, green, and blue pixels). Further, while the specification refers to red, green, and blue pixels, the present invention is not limited thereto. In other embodiments, for example, the pixels 40 may correspond to other colors, and there may be more or fewer colors of pixels than three.

The IR sensor 50 is configured to sense IR light, such as the emitted IR signals from the IR pixels 30 as they are reflected off the user (for example, off the user's corneas, such as their pupils or irises) and provide data corresponding to these reflected IR signals (e.g., strength, shape, etc.). While the IR sensor 50 shown in the display device 10 of FIG. 1 is located below the display panel 20, the present invention is not limited thereto. In other embodiments, the IR sensor 50 may be located elsewhere (such as to the side or above the display panel 20), or there may be multiple IR sensors 50, and their locations may vary (e.g., above or to the side of the display panel 20, such as at a periphery of the display panel). For instance, the display device 10 may have a second IR sensor 50′ on a right side of the display panel 20, as illustrated in FIG. 1. The multiple IR sensors 50 and 50′ may function independently or in combination (to produce, for example, stereo images).

The controller 60 controls operations of the display device 10, such as the pixels 40 of the display panel 20 (including the IR pixels 30) and the IR sensor 50. For example, the controller 60 may control when and which IR pixels 30 emit IR light. The controller 60 may also interpret the IR signals sensed by the IR sensor 50, deciding which signals (and from which IR pixels 30) correspond to reflected images being sensed by the IR sensor 50. The controller 60 is configured to control the IR pixels, the IR signals, and the IR sensor 50 to detect an eye gaze direction of the user (including, for example, an eye gaze position on the display panel 20), as described in more detail below. The controller 60 may control the pixels 40, for example, by controlling the scan driver 70 and the data driver 80. While the controller 60 is illustrated in FIG. 1 as one component, it may also be implemented as multiple components or microprocessors (for example, one for controlling image generation, one for doing image processing of the IR signals, etc.)

The pixels 40 of the display panel may be controlled by the scan driver 70 and the data driver 80. For example, the data driver may transmit data signals to columns (such as columns of pixels 40) of the display panel 20 in synchronization with scan signals transmitted by the scan driver 70 to rows (such as rows of pixels 40) of the display panel 20, as would be apparent to one of ordinary skill in the art. For instance, the scan driver 70 may transmit the scan signals to the rows of pixels 40 by corresponding scan lines while the data driver 80 may transmit the data signals to the columns of pixels 40 by corresponding data lines. In some embodiments, the IR pixels 30 are also controlled by the data signals and the scan signals, but the present invention is not limited thereto. In other embodiments, the IR pixels 30 are controlled by dedicated control lines, such as dedicated scan lines or dedicated data lines.

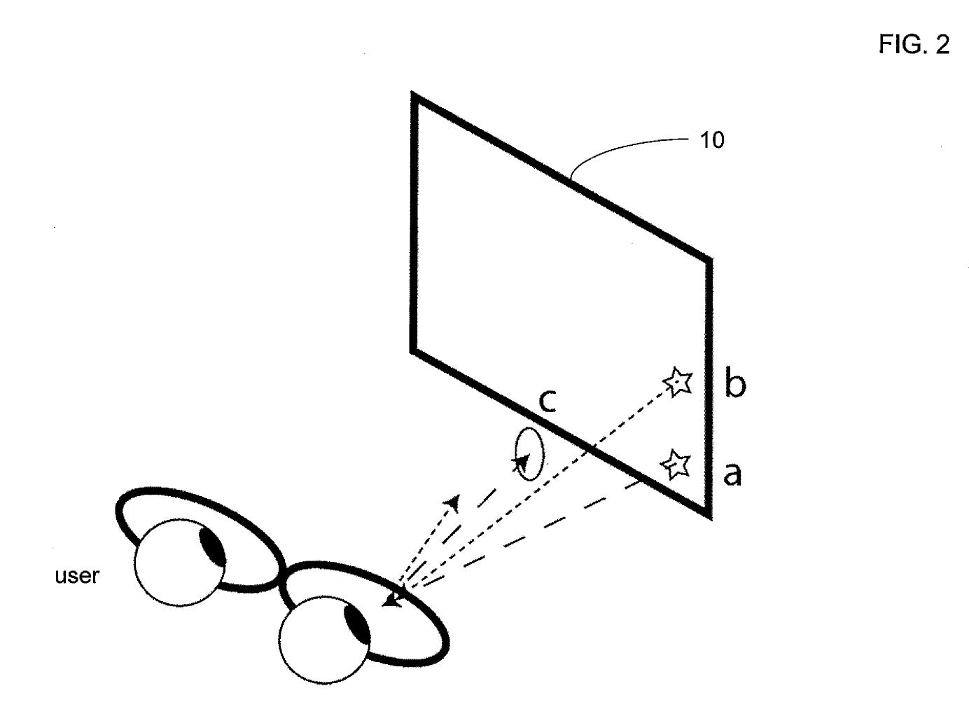

FIGS. 2-4 illustrate example operations of the IR emissive display device 10 of FIG. 1 according to embodiments of the present invention. In FIG. 2, the display device 10 is illustrated with two IR pixels, labeled ‘a’ and ‘b,’ together with an IR sensor labeled ‘c.’ A user wearing normal eyeglasses is viewing the display device 10.

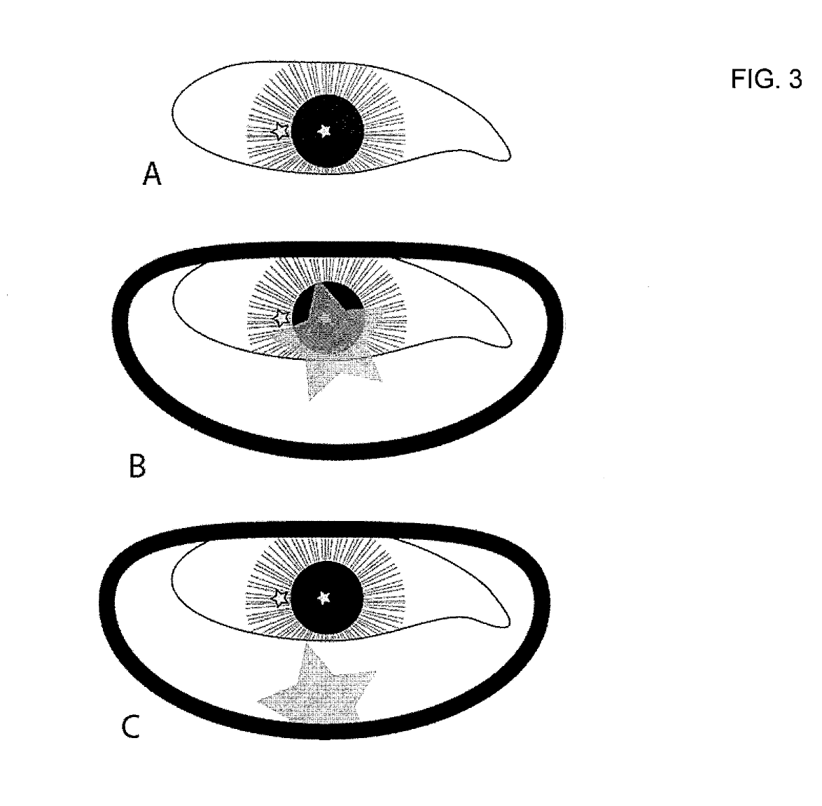

FIG. 3, which includes FIGS. 3A, 3B, and 3C, depicts various specular reflections off the user's cornea (the reflections being illustrated as small stars, representing subtle reflections) and off the user's eyeglasses (the reflections being illustrated as large stars, representing strong glare) from the IR pixels a and b as sensed by the IR sensor c. FIG. 3A depicts the user's eye without eyeglasses (and thus no issue of glare), while FIGS. 3B-3C depict the user's eye with eyeglasses. While multiple specular reflections off the cornea are simultaneously illustrated in each of FIGS. 3A-3C, the present invention is not limited thereto. In other embodiments, there may be only one specular reflection off the cornea at any given moment (for example, from a particular IR pixel emitting IR light). Further, while two specular reflections off the cornea are illustrated in each of FIGS. 3A-3C, in other embodiments, there may be 2D patterns of three or more specular reflections. These 2D patterns may be easier for image recognition devices and their controllers to recognize than single, double, or other one-dimensional patterns of IR signals.

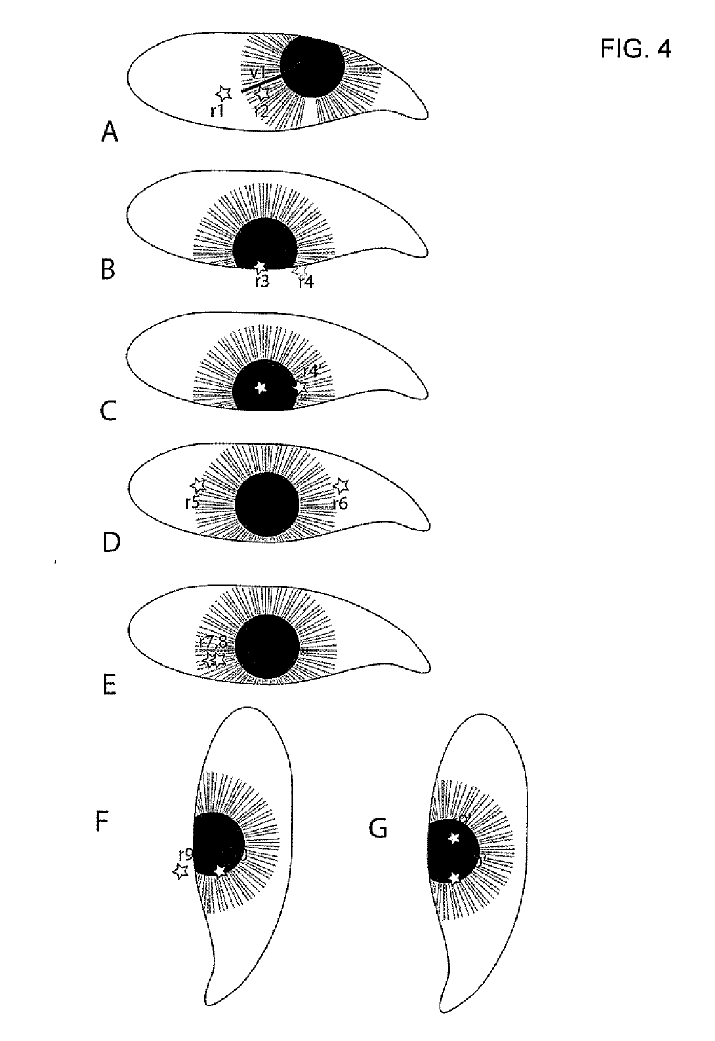

FIG. 4, which includes FIGS. 4A, 4B, 4C, 4D, 4E, 4F, and 4G, depicts various specular reflections off the user's cornea without interference of eyeglasses (as in FIG. 3A). FIGS. 4F-40 are intended to represent a user viewing a display device 10 that has been rotated 90° from a normal orientation (or a user that is viewing the display device 10 from a sidewise orientation of 90%, or any combination of user and display device orientations that results in a 90% rotation of the viewer's eyes with respect to the normal orientation of the display device 10.

In FIG. 2, the controller 60 causes the IR pixels a and b to emit IR light, which reflects off the user (such as the user's cornea or eyeglasses) and is then sensed by the IR sensor c. For example, two such specular reflections (from IR pixels a and b, or more precisely, from the IR light or signals emitted by IR pixels a and b) are illustrated in FIG. 3A, with one of the two reflections (e.g., from IR pixel a) located over the pupil and the other one (e.g., from IR pixel b) located over the iris next to the pupil.

In FIG. 3A, the IR signals form the two illuminators on the display panel are clearly visible in the IR image (as seen by the IR camera), as is the pupil of the eye. From these reflections, it is possible to detect a gaze direction of the user's eye (for example, by determining characteristics such as the shape (or size) and position of the user's pupil in addition to the locations of the specular reflections from the IR illuminators off the user's cornea) as well as the corresponding eye gaze position on the display panel, as would be apparent to one of ordinary skill using, for example, standard eye gazing algorithms. For instance, the shift in the positions of the IR emitters (or the emitters' specular reflections) with respect to the pupil can be used to estimate the gaze position with respect to the illuminators' positions. The concurrent (for example, simultaneous) use of multiple emitters allows a corresponding pattern (such as a two-dimensional pattern) of specular reflections to be more easily detected off the cornea.

In FIG. 2, the dashed lines represent the reflections' off the eyeglasses from the corresponding IR pixels a and b, with the reflection from IR pixel a coming directly off the eyeglasses to IR sensor c, thus causing a significant amount of unintended IR signal (e.g., strong glare) being received by IR sensor c that obscures or saturates the more subtle reflections off the cornea, as illustrated in FIG. 3B. In FIG. 3B, a specular reflection from the glasses obscures the pupil and corneal reflections, making it difficult to extract the pupil position and emitter reflections. That is, there is strong glare off the glasses that washes out most of the contrast around the pupil and the corneal reflections. In this case, it can be difficult to robustly estimate the eye gaze direction or position. As can be seen in FIG. 3B, the (large or strong) reflection for IR sensor a off the eyeglasses is directly over the pupil, which causes the corresponding (small or subtle) reflection for IR sensor a off the pupil to be obscured or saturated (for example, not recognized).

However, in FIG. 3C, the reflection for IR sensor b off the eyeglasses is below the cornea, and thus does not interfere with the corresponding reflection for IR sensor b off the iris. For instance, a slight shift in the height of the IR illuminators causes the specular reflection from the glasses to shift lower, which clears the IR camera's view of the pupil and iris. In other words, making a slight adjustment in the vertical position of the illuminators can shift the specular reflection from the glasses away from the pupil, making a clear view for recording signals useful for gaze algorithms. In particular, a group of IR illuminators (such as a two-dimensional group of IR pixels) can be moved as a group to a different portion of the display panel by shifting the locations of the selected IR pixels accordingly.

Referring now to FIG. 4, one of the purposes of the IR point sources is to have a stationary reference point that is fixed with respect to the display and not the head or eye. Thus, in FIG. 4A, if the observer looks upwards, the angle between the reflection and the center of the pupil (see vector v1 in relation to specular reflections r1 and r2) can be used to calculate where the eye is looking on the screen (factoring in, for example, the camera location), as would be apparent to one of ordinary skill. In this case, the eye is looking at an upper corner of the screen.

Meanwhile, in FIG. 4B, the user's head is leaned back and the eye needs to roll down to see forward. From this viewing position, one emitter's reflection (r4) is not visible by the camera, and the other (r3) is barely visible. The system may thus fail to detect the gaze correctly. However, in FIG. 4C, to correct for the failure in FIG. 4B, the emitters r3 and r4 may be shifted upwards to r3′ and r4′ on the display, making the reflections easily visible to the camera (and without requiring, for example, a change in the head position). The ability to shift the emitters' vertical (and horizontal) positions makes embodiments of the present invention more robust to head orientation.

In FIG. 4D, the observer is viewing the display from a close viewing distance, and widely separated emitters r5 and r6 create reflections that are widely separated. It may be difficult to recognize the widely spaced reflections, which may lead to errors. However, this may be addressed by bringing the reflections r5 and r6 closer together (that is, by selecting corresponding IR pixels that are closer together). In a similar fashion, in FIG. 4E, if the observer moves too far from the display, the reflections r7 and r8 may be close together and difficult to resolve. In this situation, the emitters may be shifted horizontally apart to get a clear signal.

In FIG. 4F, if the display is used sideways, horizontal reflections r9 and r10 may be on the short dimension of the eye, which may cause problems (such as reflection r9 is now blocked by the eyelid). This may be addressed as in FIG. 4G, where the horizontal reflections r9 and r10 are shifted to a vertical arrangement of the emitters r9′ and r10′. Thus, in FIGS. 4A-4G, the controller 60 may dynamically adjust which IR pixels emit IR signals to result in a more recognizable pattern of specular reflections off the cornea for the IR sensor and image recognition software.

Therefore, by using multiple IR pixels, then even if the user wears eyeglasses, a sufficient number of unobscured IR signals can be sensed by the IR sensor c to determine the gaze direction (for example, from the pupil shape (or size) and position as well as the locations of the specular reflections of the IR signals off the cornea) of the user as well as the corresponding eye gaze position on the display panel. That is, one way to mitigate the problem of reflections from eyeglasses is to use the IR emissive pixels of the display panel to shift the locations of the IR sources to locations where the reflections from the glasses does not interfere with the IR camera or other IR sensor.

An IR emissive display enables a full array of IR sources that can be used for remote gaze tracking. In addition to mitigating the interference from eyeglasses, being able to create point sources on a 2D array of IR sources (for example, IR pixels) offers opportunities to improve the accuracy of gaze estimates. The separation of the IR sources may be modulated, and a third point may be used to create a more distinctive reflection to track. For example, a two-dimensional pattern of IR sources may be used to create a corresponding more distinctive pattern of specular reflections off the cornea.

According to embodiments of the present invention, using the display panel itself for the

IR sources has several features. The position of the emitters may be changed when the IR camera detects an overwhelming reflection from eyeglasses, making the system have greater robustness to individuals wearing glasses. Further, the flexibility to have non-collinear and non-horizontal light sources (such as a 2D array of IR sources) offers the opportunity for algorithm developers to use improved 2D algorithms to identify the emitter pattern in the IR camera and ignore other specular reflections that could be caused by other point sources in the ambient lighting. In addition, by using the display panel for the IR emission, there is no longer a need for other external devices, such as a large bar beneath the display. For example, the IR camera may be embedded into the bezel of the display system at reduced cost. Furthermore, such a system including compact or embedded eye tracking may improve the user interface (UI) experience with smart phones in which touch interactions with small displays often obscures much of the content shown on the display.

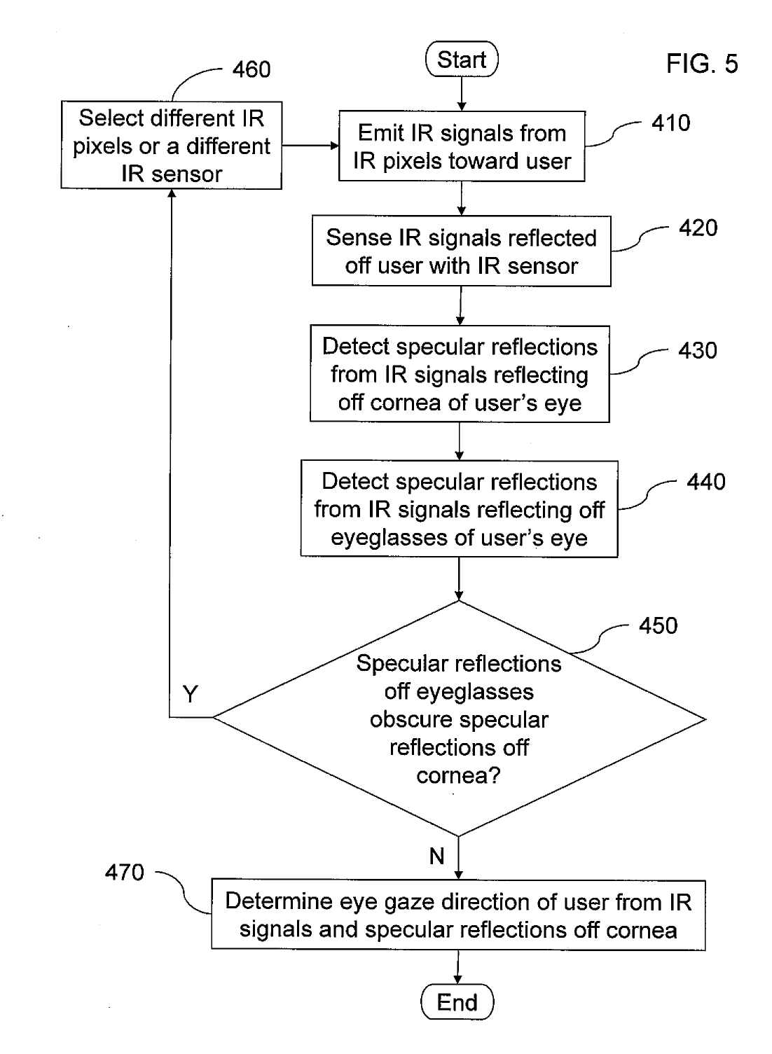

FIG. 5 is a flowchart of an example method of facilitating remote eye tracking on the display device 10 of FIG. 1 according to an embodiment of the present invention. The method of FIG. 5 may be implemented, for example, in hardware, or in software (in the form of computer instructions configured to be executed as a software routine by a processor or microprocessor). That is, a person of skill in the art should recognize, that the routine may be executed via hardware, firmware (e.g. via an ASIC), or in combination of software, firmware, and/or hardware. The computer program instructions may be stored in a memory implemented using a standard memory device, such as, for example, a random access memory (RAM). In addition, the sequence of steps is not limited thereto, and in other embodiments, the order of steps may be altered, or some of the steps may be skipped altogether as recognized by a person of skill in the art.

In FIG. 5, processing begins, and in step 410, IR signals are emitted from selected IR pixels (for example, a 2D pattern of IR pixels) toward a user of the display device. For example, the controller may select some of the IR pixels from which to emit the IR signals, and then control these IR pixels to emit the IR signals, such as sequentially or concurrently. In step 420, the IR signals reflected off the user are sensed with the IR sensor, such as an IR camera. For example, the IR signals may help illuminate the user and, in particular, the user's eyes. In step 430, specular reflections from the IR signals reflecting off the cornea of the user's eye (or eyes) are detected. For example, single or specific patterns of IR pixels may emit IR signals and the controller may control the IR camera to detect their emitted IR signals reflecting off the cornea(s) of the user using image recognition routines as would be apparent to one of ordinary skill. These images allow the controller to detect where the user is looking (e.g., gaze direction) through use of standard gaze tracking algorithms.

In step 440, specular reflections from the IR signals reflecting off eyeglasses (such as the lenses of the eyeglasses) of the user's eye are detected. These reflections may be significantly more noticeable than the specular reflections off the cornea, and may obscure the cornea reflections when they coincide, such as in FIG. 3B. The controller may detect these specular reflections similarly to the specular reflections off the cornea, such as by using image recognition routines as would be apparent to one of ordinary skill. In step 450, a determination is made if the specular reflections off the eyeglasses are obscuring the specular reflections off the cornea. For example, from processing the two different specular reflections in steps 430 and 440, the controller may determine that specular reflections off the cornea that should be observable by the IR camera are being obscured by the specular reflections off the eyeglasses and, as a result, are either not being detected, or being detected too faintly to recognize as specular reflections off the cornea.

If the controller determines in step 450 that the specular reflections off the eyeglasses are obscuring the specular reflections off the cornea, then processing proceeds to step 460, where different IR pixels are selected or a different IR camera is selected. By choosing IR pixels in different rows or columns, or by using a different IR camera, the controller may be able to move the specular reflections from directly over the cornea to a less noticeable portion of the eyeglasses, as would be apparent to one of ordinary skill in the art. Processing may then resume with step 410, emitting IR signals from the (possibly newly) selected IR pixels toward the user.

Otherwise, if the controller determines in step 450 that the specular reflections off the eyeglasses are not obscuring the specular reflections off the cornea, then processing proceeds to step 470, where the eye gaze direction of the user (such as the position of the display panel towards which the user is gazing) from the IR signals and the specular reflections off the cornea. For this purpose, the controller may use an eye gazing algorithm as is known to a person of ordinary skill in the art.

While the present invention has been described in connection with certain example embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An infrared (IR) emissive display device comprising:
a display panel comprising IR pixels configured to emit IR light and arranged in a first two-dimensional (2D) pattern;
an IR sensor configured to sense IR signals emitted from the IR pixels reflected off a user of the display device; and
a controller configured to control the IR pixels, the IR signals, and the IR sensor to detect a gaze direction of an eye of the user.

2. The IR emissive display device of claim 1, wherein
the display panel further comprises red pixels configured to emit red light, green pixels configured to emit green light, and blue pixels configured to emit blue light,
the controller is further configured to control the red pixels, the green pixels, and the blue pixels, and
the first 2D pattern of the IR pixels corresponds to a 2D pattern of the red pixels, the green pixels, or the blue pixels.

3. The IR emissive display device of claim 2, wherein the IR pixels are as numerous as the red pixels, the green pixels, or the blue pixels.

4. The IR emissive display device of claim 1, wherein the IR sensor is at a periphery of the display panel.

5. The IR emissive display device of claim 4, wherein the IR sensor comprises a plurality of IR sensors.

6. The IR emissive display device of claim 5, wherein the IR sensors are on multiple sides of the periphery of the display panel.

7. The IR emissive display device of claim 1, further comprising:
a scan driver configured to generate and transmit scan signals to rows of the display panel; and
a data driver configured to generate and transmit data signals to columns of the display panel,
wherein the controller is further configured to control the scan driver and the data driver.

8. The IR emissive display device of claim 7, wherein the IR pixels are further configured to be driven by the scan signals or the data signals.

9. The IR emissive display device of claim 1, wherein the controller is further configured to control multiple ones of the IR pixels arranged in a second 2D pattern to concurrently emit the IR signals.

10. The IR emissive display device of claim 1, wherein the IR sensor is an IR camera.

11. The IR emissive display device of claim 1, wherein
the controller is further configured to:
control the IR pixels, the IR signals, and the IR sensor to detect specular reflections from the IR signals reflecting off a cornea of the user's eye; and
detect the gaze direction of the user's eye by using the detected specular reflections off the cornea, and
the IR sensor is further configured to detect a center of a pupil of the eye.

12. The IR emissive display device of claim 11, wherein the controller is further configured to control a spacing or orientation of selected ones of the IR pixels for emitting the IR signals to produce a more recognizable pattern of the specular reflections off the cornea.

13. The IR emissive display device of claim 11, wherein the controller is further configured to:
control the IR pixels, the IR signals, and the IR sensor to detect specular reflections from the IR signals reflecting off eyeglasses of the user's eye; and
detect the gaze direction of the user's eye by not using the detected specular reflections off the eyeglasses.

14. The IR emissive display device of claim 13, wherein the controller is further configured to select different ones of the IR pixels from which to emit the IR signals in response to the detected specular reflections off the eyeglasses.

15. The IR emissive display device of claim 13, wherein
the IR sensor comprises a plurality of IR sensors, and
the controller is further configured to select a different one of the IR sensors from which to sense the IR signals in response to the detected specular reflections off the eyeglasses.

16. A method of facilitating remote eye tracking on a display device comprising a display panel having IR pixels configured to emit IR light and arranged in a two-dimensional pattern, an IR sensor configured to sense IR signals emitted from the IR pixels reflected off a user of the display device, and a controller configured to control the IR pixels, the IR signals, and the IR sensor to detect a gaze direction of an eye of the user, the method comprising:
emitting the IR signals from the IR pixels toward the user;
sensing the IR signals reflected off the user with the IR sensor; and
detecting the gaze direction of the user's eye from the sensed IR signals.

17. The method of claim 16, further comprising detecting specular reflections from the IR signals reflecting off a cornea of the user's eye, wherein the detecting of the gaze direction of the user's eye comprises using the detected specular reflections off the cornea.

18. The method of claim 17, further comprising detecting specular reflections from the IR signals reflecting off eyeglasses of the user's eye, wherein the detecting of the gaze direction of the user's eye comprises not using the detected specular reflections off the eyeglasses.

19. The method of claim 18, further comprising selecting different ones of the IR pixels from which to emit the IR signals in response to the detected specular reflections off the eyeglasses.

20. The method of claim 18, wherein
the IR sensor comprises a plurality of IR sensors, and
the method further comprises selecting a different one of the IR sensors from which to sense the IR signals in response to the detected specular reflections off the eyeglasses.
